(19) United States
(12) Patent Application Publication
(10) Pub. No.: US 2014/0224851 A1
(43) Pub. Date: Aug. 14, 2014

(54) Fender bag for all terrain vehicles

(71) Applicants: Jeffrey D. Hancock, Uintah, UT (US); Christopher N. Schenck, Uintah, UT (US)

(72) Inventors: Jeffrey D. Hancock, Uintah, UT (US); Christopher N. Schenck, Uintah, UT (US)

(21) Appl. No.: 13/815,223

(22) Filed: Feb. 11, 2013

(51) Int. Cl. B60R 9/02

(52) U.S. Cl. CPC B60R 9/02
USPC 224/401

(57) ABSTRACT

A fender bag for all terrain vehicles, and the like, having a pouch with a rectangular shaped open receiving end and a flip top cover connected by a hinge to the pouch and pivoted to close the receiving end. A receptacle having spaced apart side and end walls interconnected by a bottom and having an open top is sized and shaped to fit either bottom, or a side wall, first, through the open receiving end of the pouch, to thereby accommodate access to the interior of the pouch whether the bag is positioned in an upright position or a horizontal position. The extent of insertion of the receptacle into the pouch is determined by easily repositioned shelf brackets secured to inner surfaces of opposed spaced apart side or end walls. The flip top cover will close the bag over the inserted receptacle and articles placed therein at all inserted positions of the receptacle.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

This invention relates to storage bags intended to be mounted on fenders of all-terrain vehicles, and the like.

Prior Art

All terrain vehicle users' frequently have many selected articles that they want conveniently available to them while travelling on their vehicles or during stops made during, before, or after, travel on the vehicles. Such articles may include, for example; binoculars, telephones, GPS locators, signaling devices, range finders, first aid kits, some tools for vehicle repair, knives and even some handguns. All terrain vehicles, generally, have limited compartments, pockets or other storage locations built into the vehicles to receive and hold such articles until the operator decides to retrieve and use the articles. Storage compartments originally provided on an all terrain vehicle also may not be positioned to be easily accessed by an operator or a passenger riding on the vehicle, and access may be particularly difficult during vehicle travel.

In the past, many storage bags have been proposed, developed and sold for attachment to all terrain vehicles, which may be wheeled vehicles or tracked vehicles. Some of these bags fit on and attach to support racks of all-terrain vehicles and others have been designed to be mounted on and to conform to the shape of the fenders of the all terrain vehicles. However, there remains a need for a bag having a storage compartment that can be easily re-configured and restyled to facilitate and best accommodate articles to be placed therein, and to facilitate easy removal of some articles from a readily accessible configured compartment, without the user having to sift through all articles carried in a bag

### SUMMARY OF THE INVENTION

### Objects of the Invention

Principal objects of the present invention are to provide a storage bag that can be readily secured to and thereafter be readily removed from an upper surface of a fender of an all terrain vehicle, and the like.

Other objects are to provide such a bag having a bag closure that will open to allow easy access by a user to the interior of the bag and selected contents thereof while effectively keeping dust and moisture from entering the bag, during use of the closed bag.

Still other objects are to provide a receptacle that will fit within the bag, through the bag closure to form differently configured compartments within the bag interior, insuring that separated content placed in the bag remains separated, while still making certain selected content more readily available, for quick and easy removal from the bag.

Yet other objects are to provide low cost, easily repositioned shelf brackets within the bag to support a receptacle in one of a plurality of selected, desired orientations.

### Features of the Invention

Principal features of the invention include a storage bag having a back surface with a central core of substantially rigid material, such as plastic. The flat core extends downwardly between similar flat, spaced outer side wall cores of the bag and from a top of the bag to curve forwardly, in engagement with curved bottom edges of the side wall cores, to form a bag bottom. The flat core also engages the spaced apart side wall cores at bottoms of the side wall core edges and follows the curved side wall core edges upwardly to beneath upper curved edges of the side walls. The central core, and the spaced apart side cores having top and bottom curved edges are covered on both inner and outer surfaces with fabric sewn, or otherwise secured, to hold the central core and side wall cores together and to thereby form a storage bag pouch with an interior and a top front opening.

A flip top lid cover has a fabric covered curved core and spaced apart, fabric covered side edges shaped to fit over the top front opening. Fabric covering one edge of the curved core is sewn, or otherwise attached to the fabric covering the flat core at the top rear of the bag and serves as a hinge for the lid.

Easily released latch means secure the flip top lid closed over the top front opening.

A pair of spaced parallel attachment strips of hook and loop material, such as that commercially known by and hereinafter referred to by the trade name, “VELCRO”, are affixed to each interior surface of the side walls of the bag.

The attachment strips are positioned to extend from just above the bottom of the bag to just below the bottom of the top front opening and each strip has the same strip material, i.e., looped material or hooked material, facing the interior of the bag.

A pair of easily constructed and inexpensive, lightweight shelf brackets, each having an anchor strip with a face of either the looped material or hooked material that is cooperative with the material of the attachment strips that face the interior of the bag are used to position a receptacle in the bag pouch. The anchor strip of each shelf bracket extend from across one attachment strip on one side wall of the bag to across the other attachment strip on the same side wall of the bag. The shelf brackets are easily adjusted along the lengths of the attachment strips by pulling the anchor strips-from the attachment strips, repositioning the shelf brackets along the attachment strips and again pushing the shelf supports against the side walls to interlock the cooperative loop and hook materials.

A receptacle has front, rear and spaced apart side walls and a bottom interconnecting the front rear and side walls and an open top. The receptacle may fit snugly into the open top front of the bag, with opposite edges of the bottom resting on the shelf brackets. In this position the open top of the receptacle is above or below the top edge of the front wall of the bag, depending on the position of the shelf brackets and is open towards the top of the bag. With this receptacle orientation and the bag positioned to be readily accessible on an ATV vehicle fender, in an upright or tilted bottom to top position articles, such as binoculars, telephone, GPS unit, etc. placed in the receptacle are readily accessed by the user, merely by first flipping the top lid cover to its open position. At the same time, other articles positioned and carried in the bag beneath the bottom of the receptacle are maintained separated from articles in the receptacle and are not disturbed during removal of an article or articles carried in the receptacle. Although the carrying space in the receptacle will not change, the space in the receptacle and above the receptacle, but beneath the flip top lid, will change as the shelf brackets are vertically repositioned on the anchor strips affixed to the inside of the side walls of the bag. This allows articles of different sizes, shapes and other characteristics to be carried in and extending above the receptacle, while maintaining separation from articles tarried in the bottom of the pouch in a manner permitting more ready retrieval of the selected articles placed in the receptacle.

The receptacle may be alternatively timed by a user to position edges of either side wall to be supported on the shelf brackets. This arrangement of the receptacle: is particularly suitable when the bag is attached to an ATV fender and is horizontal, or substantially horizontal when the vehicle is on a level or substantially level surface. With the receptacle to be so arranged a user can place articles in the bag; in the spate between the bottom of the bag and the bottom of the side wall that is resting on the adjustable shelf brackets before positioning the receptacle. Additional articles to be maintained separate and available for easy, quick retrieval are then placed in the receptacle through the upwardly turned top front inlet opening of the bag. Articles in the receptacle can thereafter be easily retrieved by the user, without disturbing other articles in the bag, merely by first flipping the bag top lid open.

Additional objects and features of the invention will become apparent from the hereinafter set forth detailed description and drawings, to those skilled in the art to which the invention pertains

### THE DRAWINGS

### Brief Description of the Drawings

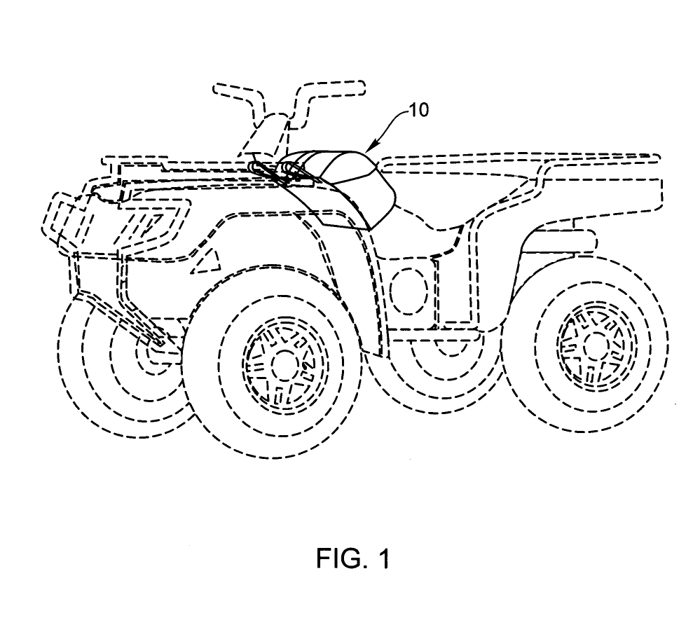

FIG. 1 is a bag of the invention, shown mounted on a fender of an AN wheeled vehicle, shown in phantom;

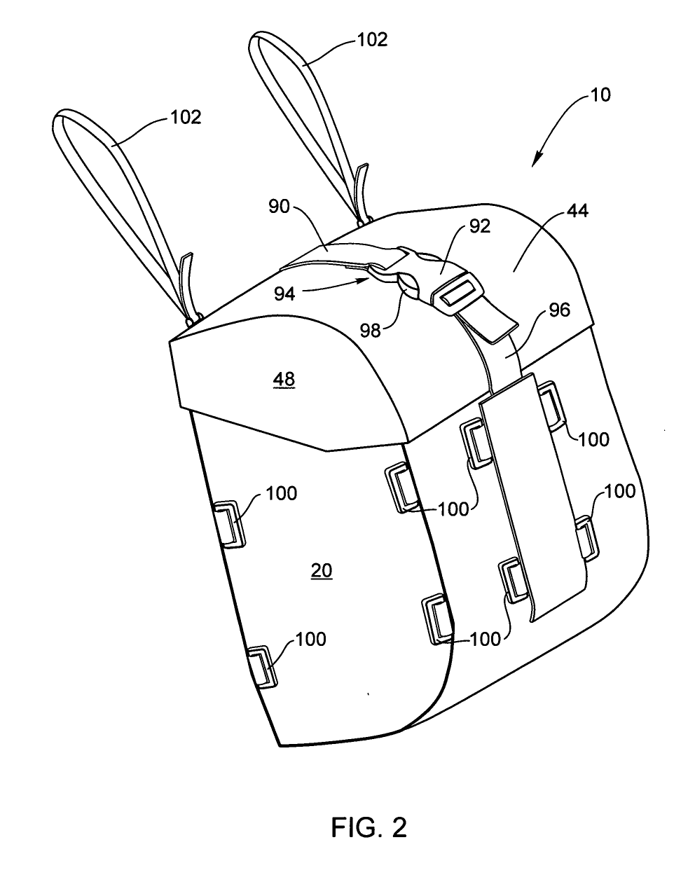

FIG. 2, an enlarged perspective view of the bag, with the bag flip lid closed;

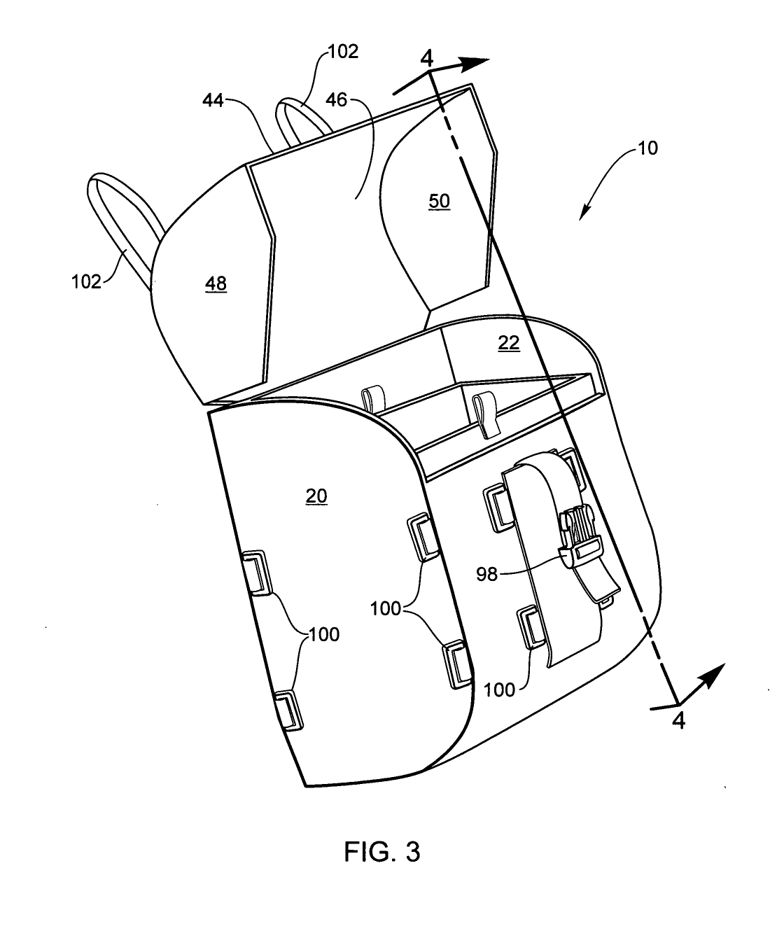

FIG. 3, a view like that of FIG. 2, with the flip lid open;

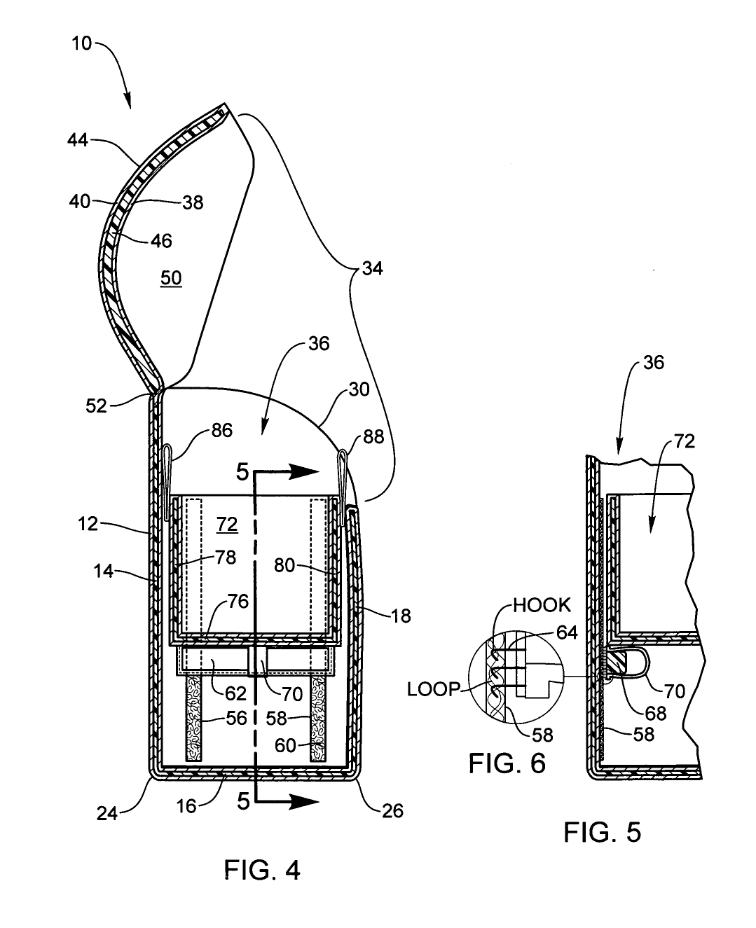

FIG. 4, a vertical section taken on the line 4-4 of FIG. 3;

FIG. 5, a vertical section taken on the line 5-5 of FIG. 4;

FIG. 6, an exploded and enlarged pictorial view of the typical hook and loop material used as connectors;

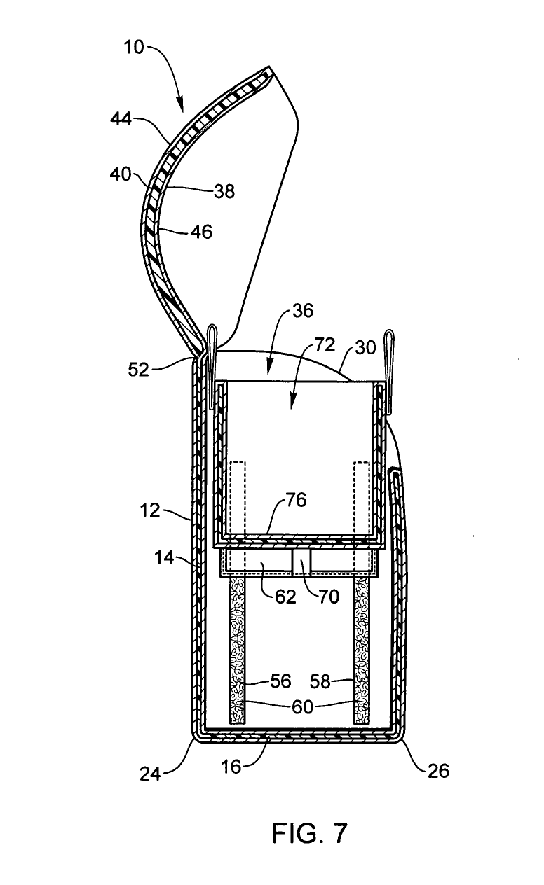

FIG. 7, a view like that of FIG. 4, but showing the receptacle raised in the bag pouch;

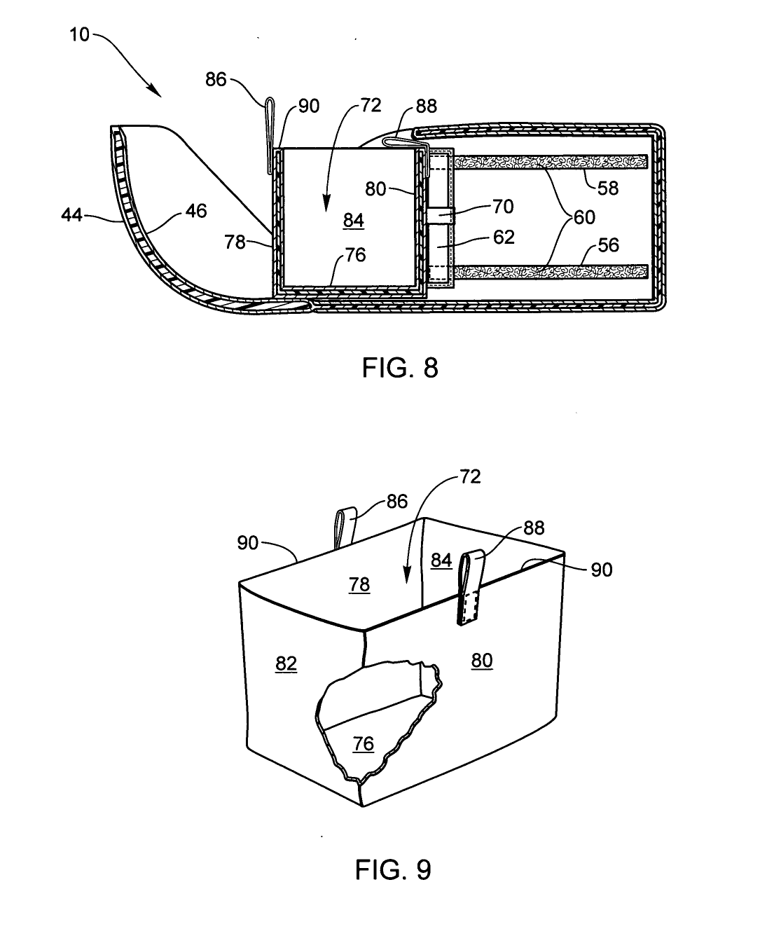

FIG. 8, a view like that of FIG. 4, but showing the fender bag in a horizontal position and the receptacle rotated and a side wall thereof fully inserted into the bag pouch;

FIG. 9, a view like that of FIG. 8, but with the receptacle pulled from the bag pouch to position the wall at the opening to the pouch.

### LISTING OF COMPONENTS AND NUMERALS APPLIED THERETO

The numbers applied to components of the invention are as follows:

### Numerals Components

10 bag.

12 bag back surface.

14 rigid core of back surface.

16 core of sidewall 20.

18 core of sidewall 22.

20 sidewall of bag 10.

22 sidewall of bag 10.

24 lower curved edge, of core 16.

26 lower curved edge of core 18.

28 upper curved edge of core 16.

30 upper curved edge of core 18.

32 top edge of inlet opening 34 of bag pouch 36.

34 inlet opening of bag pouch 36.

38 inner faces of cores 14, 16, and 18.

40 fabrics.

42 pouch of bag 10.

44 flip top cover.

46 curved central core.

48 flat side core of flip top cover 44.

50 flat side core of flip top cover 44.

52 hinge connection.

56 fabric strip.

58 fabric strip.

60 exposed faces of strips 56 and 58.

62 shelf support.

64 backing member of shelf supports.

66 attachment surface of backing member 64.

68 elongate, fabric covered foam plastic rib.

70 finger loop.

72 receptacle

76 bottom of receptacle 72.

78 rectangular side wall of receptacle 72.

80 rectangular side wall of receptacle 72.

82 square end wall of receptacle 82.

84 square end wall of receptacle 82.

86 pull tab.

88 pull tab.

90 adjustable strap.

92 female latch receiver member.

94 latch.

96 adjustable strap.

98 male latch insert member.

100 D-rings:

102 straps.

### DETAILED DESCRIPTION OF THE INVENTION

Referring now to the drawings:

In the illustrated preferred embodiment of the invention, the storage bag 10 is shown in FIG. 1, mounted on a fender of a wheeled ATV (all-terrain-vehicle), shown in phantom. Bag 10 is mounted on a rear slope of a top surface of a front fender of the ATV where it is conveniently available to an operator of the ATV and is in a tilted upright position.

As shown best in FIGS. 4-9, bag 10 has a back surface 12, including a substantially rigid core 14, made of plastic, or the like, that extends forwardly from a top of the bag between rear edges of spaced apart similar cores 16 and 18, respectively, of sidewalls 20 and 22. The core 14 follows bottom and lower curved edges 24 and 26 of the cores 16 and 18, curves upwardly to the bottoms of upper curves 28 and 30 of the cores 16 and 18 and forms a top edge 32 of a top, front inlet opening 34 of a bag pouch 36.

Inner and outer faces of the cores 14, 16 and 18 are respectively covered with fabrics 38 and 40 that are sewn to hold the cores together and to form pouch 36 of bag 10.

A flip top lid cover 44 is provided to cover inlet opening 34 of the bag pouch 36. The flip top Cover 44 also has a curved central core 46 interconnecting spaced apart flat side cores 48 and 50. The cores 46, 48 and 50 are also respectively covered with and held together to form the flip top lid cover, by inner and outer fabrics 38 and 40. The fabric covered, spaced apart cores 48 and 50 are spaced to slide against the fabric covered cores 16 and 18 as the cover is pivoted to open and close the bag pouch 36. The fabrics 38 and 40, between the pouch 36 and top lid cover 44 form a hinge connection 52 between the flip top cover 44 and the pouch 36 of the bag 10.

Opening 34 of the pouch 36 of the bag 10 has a rectangular configuration formed by the interconnected, upwardly curved portions of fabric covered core 14 and the spaced apart fabric covered side wall cores 16 and 18.

A pair of fabric strips 56 and 58, each having an exposed face 60, are spaced apart and sewn, or otherwise vertically affixed, to the inner fabric 38 of each core 16 and 18. The exposed faces 60 are the same and are either a hook or a loop material, such as is common to VELCRO™ products. Each pair of strips 56 and 58 serve as supports for a shelf support 62.

Each shelf support 62 has a backing member 64 with a length sufficient to extend across both strips 56 and 58 attached to a core 16 or 18. An attachment surface 66 of each backing member 64 comprises a hook or loop material surface that will cooperate with the material of the exposed faces 60 of fabric strips 56 and 58 to secure the shelf supports transversely across the fabric strips.

Each shelf support 62 has an elongate, fabric covered foam plastic rib 68 attached to and projecting from the face of the backing member 64 opposite to the attachment surface 66. A finger loop 70 is sewn or otherwise attached to the backing member and projects there from to provide a means for pulling and removing each shelf support from engagement with a pair of parallel strips 56 and 58. A shelf support 62 is adjustably attached to each pair of strips 56 and 58 such that the ribs 68 are parallel and similarly spaced from the bottom of the pouch 36. The ribs 68 project from and provide support for a receptacle 72.

Receptacle 72 has a bottom 76 interconnecting spaced apart, rectangular side walls 78 and 80 that are connected to spaced apart square end walls 82 and 84. Pull tabs 86 and 88 are respectively attached to centers of top edges 90 of side walls 78 and 80. Receptacle 72 is sized and shaped such that it can be inserted either bottom or a side first, through the opening of the pouch of the bag and into the pouch 36 while being in close sliding engagement with the fabric covered back core 14 and side cores 16 and 18 of the bag 10.

The bottom 76, or a side wall 78 or 80 of the inserted receptacle 72 rests on the ribs 68 of shelf supports 62 and the distance the receptacle is inserted into the pouch 36 is determined by the positioning of the shelf supports 62. A user, in determining the positioning of the shelf supports 62, determines whether the bag is to be mounted on an ATV in an upright or tilted position or in a horizontal or substantially horizontal position. The user determines the size, dimensions and other characteristics of the article or articles to be kept separated from other articles carried in the bag and then positions the shelf mounts such that the space in and above, or in the inserted receptacle, when the flip top cover 44 is closed, will accommodate such separated article or articles. Other articles may be stored in the bag 10, before insertion of the receptacle, and between the inserted bottom or an inserted side wall of the receptacle 72, to be retrieved, when desired, after removal of the receptacle 72 from the opening 34 of the bag 10.

An adjustable strap 90 has one end attached to the top of flip top cover 44 and a conventional female latch receiver member 92 of a latch 94 on the other end. Another adjustable strap 96 has one end attached to the front of pouch 42. The other end of strap 94 has a conventional male latch insert member 96 that is inserted into member 92 to secure the flip top cover in position closing the pouch 42. Latch 94 is easily released and the flip top cover is easily pivoted open with one hand by a user desiring to retrieve an article from the receptacle

Additional loops 98 and straps 100 may be attached to the pouch 42, to be used in securing the bag 10 to a fender of an ATV vehicle, if desired.

Although a preferred embodiment of the invention has been herein disclosed, it is to be understood that such disclosure is by way of example and that variations are possible without departing from the subject matter corning within the scope of the following claims, which claims define our invention.

We claim:

1. A storage bag for mounting on fenders of AN vehicles, and the like, comprising:
an article receiving pouch having a substantially rigid back member interconnecting edges of substantially rigid, spaced apart parallel side walls, a bottom and a front wall interconnecting said side walls and extending upwardly from said bottom to a spaced distance from a top of said back member, whereby an upper edge of said front wall, together with said spaced apart side walls forms a rectangular opening into said pouch;
a receptacle having a pair of parallel end walls, a pair of parallel side walls and a rectangular bottom interconnecting each of said end and side walls, said receptacle having a size to fit closely through said rectangular opening of said pouch and to conform to the shape of said interior of said pouch;
support means in said pouch to support said receptacle at a desired position in said pouch;
means to selectively change the desired support position in said pouch;
a top cover for said pouch, said top cover being connected to and extending from said back member, downwardly over edges of said side walls and said front edge;
a hinge interconnecting said top cover and said pouch; and
means for releasably latching said top cover to said pouch when said top cover is closed.

2. A storage bag as in claim 1, wherein said support means comprises shelf supports attached to the parallel side walls of the pouch.

3. A storage pouch as in claim 2, wherein said shelf supports are attached to the parallel side walls of said pouch by hook and loop engaging means respectively secured to said parallel side walls and said shelf supports.

4. A storage pouch as in claim 3, wherein the means to selectively change the desired support position in said pouch includes a pair of spaced apart parallel strips fixed to each parallel side wall of said pouch, said strips extending from adjacent the bottom of said pouch to adjacent the opening into said pouch and wherein the shelf supports are secured across said spaced apart parallel strips by the hook and loop attachment means.

5. A storage pouch as in claim 4, wherein each shelf support includes an elongate body with an engagement surface having a length to extend across said parallel strips, said parallel strips and said engagement surface having interlocking hook and loop surfaces thereon.

6. A storage pouch as in claim 5, wherein each shelf support includes a loop of fabric projecting into said pouch when said shelf support is secured to said parallel strips.

7. A storage pouch as in claim 6, wherein the elongate body of each shelf support is made of foam plastic and is covered with fabric material.

8. A support shelf for receptacles and the like comprising:
an elongate body member, formed from foamed plastic material covered with fabric material;
an engagement surface extending the length of said elongate body member, at one side of said elongate body member, said engagement surface having a face of material made to interlock with material of another engagement surface whereby said interlocking engagement surfaces are connectable with loop and hook connectors.

9. A support shelf as in claim 8, further including a pull tab fixed to and projecting from a side of the elongate body member opposite said engagement surface.
